(19) United States
(12) Patent Application Publication
(10) Pub. No.: US 2019/0050383 A1
(43) Pub. Date: Feb. 14, 2019

(54) METHOD OF PROVIDING DATA MANAGEMENT SERVICE CAPABLE OF COLUMN GROUPING AND SERVICE PROVIDING SERVER FOR PERFORMING THE SAME

(71) Applicant: EMRO CO., LTD., Seoul (KR)

(72) Inventor: Jae Huen KIM, Seoul (KR)

(21) Appl. No.: 15/692,658

(22) Filed: Aug. 31, 2017

(30) Foreign Application Priority Data
Aug. 11, 2017 (KR) 10-2017-0102202

(51) Int. Cl. G06F 17/24; G06F 17/21; G06F 17/30

(52) U.S. Cl. CPC G06F 17/245; G06F 3/0486; G06F 17/30601; G06F 17/212

(57) ABSTRACT

A method of providing a data management service capable of column grouping by a service providing server may include: receiving header area information about a header area through an operation page provided to a user terminal, wherein a first group including a first sub-group and a second sub-group as sub-groups thereof, a second group having predetermined columns grouped as sub-columns therein, and one or more columns are listed in the header area; performing data arrangement on the basis of the received header area information such that data values of a plurality of columns are listed corresponding to position information about headers of the plurality of columns included in the header area wherein the headers are positioned in each of a plurality of rows; and processing a table in which the data arrangement is completed to be displayed on the operation page.

### CROSS-REFERENCE TO RELATED APPLICATION

This application claims priority to and the benefit of Korean Patent Application No. 2017-0102202, filed on Aug. 11, 2017, the disclosure of which is incorporated herein by reference in its entirety.

### BACKGROUND

### 1. Field of the Invention

The present invention relates to a method of providing a data management service capable of column grouping and a service providing server for performing the method, and more specifically, to a method of providing a data management service capable of column grouping by allowing grouping of a plurality of columns listed on an operation page provided to a user terminal, thereby enabling a user to browse data of a plurality of columns at once by grouping the plurality of columns, without scrolling in the horizontal direction and a service providing server for performing the method.

### 2. Discussion of Related Art

Recently, as the Internet has become more popular and the performance of computers and networks has improved, various formats of programs related to business performance have been developed.

Particularly, as a demand for a program that enables analysis and inquiry of a large amount of data in most tasks is gradually increasing, the development of a program for facilitating data analysis, such as Excel, is actively progressing, and accordingly, web-based business programs are becoming popular because they can be implemented through web pages, enabling users to view, analyze, and create data through mobile terminals without being restricted by time, place, or terminal.

However, the web-based business programs similar to Excel which are used so far do not have a separate grouping function, so that when a user wishes to browse a plurality of columns, side scrolling must be performed in order to browse a desired column.

Therefore, there is an increasing demand for a service providing method which enables the user to browse the maximum amount of data in a limited screen caused by a user's arbitrary layout change, thereby increasing convenience in a user's inquiry of data composed of a plurality of rows, and there is an urgent need for a solution for solving the above problems.

### SUMMARY OF THE INVENTION

The present invention is made to solve the above-described problems of the related art, and one objective of the present invention is to provide a method of grouping a plurality of columns arranged in a row, thereby allowing a plurality of groups or columns to be located in one group, which provides convenience to a user when browsing a data table, without causing the user to inconveniently side scroll for browsing data of the plurality of columns.

Another objective of the present invention is to allow the configuration of a data table to be changed freely according to the setting, thereby providing the user with data tables in various layouts.

However, the objective of the present invention is not limited to the above description and various other objectives can be clearly understood by those skilled in the art from the following description.

In one general aspect, there is provided a method of providing a data management service capable of column grouping by a service providing server, the method including: receiving header area information about a header area through an operation page provided to a user terminal, wherein a first group including a first sub-group and a second sub-group as sub-groups thereof, a second group having predetermined columns grouped as sub-columns therein, and one or more columns are listed in the header area; performing data arrangement on the basis of the received header area information such that data values of a plurality of columns are listed corresponding to position information about headers of the plurality of columns included in the header area wherein the headers are positioned in each of a plurality of rows; and processing a table in which the data arrangement is completed to be displayed on the operation page.

One or more columns may be grouped as sub-columns in each of the first sub-group and the second sub-group.

In the header area information, a group header describing identification information of a group may be positioned at a top of each of the second group, the first sub-group and the second sub-group, into which the one or more columns are grouped as sub-columns.

The performing of the data arrangement may include performing the data arrangement such that data values of the second sub-group are listed below data values of the first sub-group in each of the plurality of rows when the first sub-group includes the second sub-group as a sub-group thereof and headers of one or more columns included in the second sub-group are positioned below headers of one or more columns included in the first sub-group in the header area.

The performing of the data arrangement may include performing the data arrangement such that data values of a plurality of columns of the second group are horizontally or vertically listed in each of the plurality of rows when header area information in which an arrangement direction of the sub-columns of the second group is changed to a horizontal or vertical direction is received.

The receiving of the header area information may include receiving the header area information in which a header of the second group is set to be hidden or displayed.

The performing of the data arrangement may include performing the data arrangement in a case where a header of a predetermined sub-column of the second group is set to be displayed even when a header of a predetermined sub-column of the second group is set to be hidden.

The processing of the table may include processing the table to be displayed on the operation page wherein the table includes a footer area corresponding to position information about positions of headers of each of the plurality of groups included in the header area or positions of headers of each of the columns.

The receiving of the header area information may include receiving the header area information in which a position of a specific column is changed through a user's dragging operation on the operation page.

The method may further include storing a position change log of a specific column when header area information in which a position of the specific column is changed through user's dragging operation on the operation page is received.

In another general aspect, there is provided a service providing server including: a header area information receiver configured to receive header area information about a header area through an operation page provided to a user terminal, wherein a first group including a first sub-group and a second sub-group as sub-groups thereof, a second group having predetermined columns grouped as sub-columns therein, and one or more columns are listed in the header area; a data arranger configured to perform data arrangement on the basis of the received header area information such that data values of a plurality of columns are listed corresponding to position information about headers of the plurality of columns included in the header area wherein the headers are positioned in each of a plurality of rows; and a display processor configured to process a table in which the data arrangement is completed to be displayed on the operation page.

One or more columns may be grouped as sub-columns in each of the first sub-group and the second sub-group.

In the header area information, a group header describing identification information of a group may be positioned at a top of each of the second group, the first sub-group and the second sub-group, into which the one or more columns are grouped as sub-columns.

The data arranger may perform the data arrangement such that data values of the second sub-group are listed below data values of the first sub-group in each of the plurality of rows when the first sub-group includes the second sub-group as a sub-group thereof and headers of one or more columns included in the second sub-group are positioned below headers of one or more columns included in the first sub-group in the header area.

The data arranger may perform the data arrangement such that data values of a plurality of columns of the second group are horizontally or vertically listed in each of the plurality of rows when header area information in which an arrangement direction of the sub-columns of the second group is changed to a horizontal or vertical direction is received.

The header area information receiver may receive the header area information in which a header of the second group is set to be hidden or displayed.

The data arranger may perform the data arrangement as in a case where a header of a predetermined sub-column of the second group is set to be displayed even when a header of a predetermined sub-column of the second group is set to be hidden.

The display processor may process the table to be displayed on the operation page wherein the table includes a footer area corresponding to position information about positions of headers of each of the plurality of groups included in the header area or positions of headers of each of the columns.

The header area information receiver may receive the header area information in which a position of a specific column is changed through a user's dragging operation on the operation page.

The service providing server may further include a log storage unit configured to store a position change log of a specific column when header area information in which a position of the specific column is changed through a user's dragging operation on the operation page is received.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram schematically illustrating a configuration of a system for providing a data management service which is capable of column grouping according to one embodiment of the present invention;

FIG. 2 is a block diagram illustrating a configuration of a service providing server according to one embodiment of the present invention;

FIG. 3 is a diagram illustrating an operation page displaying a table in which predetermined columns are grouped;

FIG. 4 is a diagram illustrating an operation page on which a table in which an arrangement direction of sub-columns of the second group is changed is displayed according to one embodiment of the present invention;

FIGS. 5A and 5B are diagrams illustrating an operation page on which a table in which a group header or a header of a sub-column in a group is set to be hidden is displayed according to one embodiment of the present invention;

FIG. 6 is a diagram illustrating an operation page in which a table including a footer area is included according to one embodiment of the present invention; and

FIG. 7 is a diagram illustrating an operation page on which a table in which a position of a specific column is changed through a user's dragging operation is displayed according to one embodiment of the present invention.

### DETAILED DESCRIPTION OF EXEMPLARY EMBODIMENTS

Hereinafter, the present invention will be described more fully with reference to the accompanying drawings, in which exemplary embodiments of the invention are shown. The present invention may, however, be embodied in many different forms and should not be construed as being limited to the embodiments set forth herein. Also, irrelevant details have been omitted from the drawings for increased clarity and conciseness, and similar parts are indicated by similar reference numerals throughout the detailed description.

Throughout the specification, it will be understood that when an element is referred to as being “connected to” another element, it can be directly connected to the other element, or intervening elements may be present. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

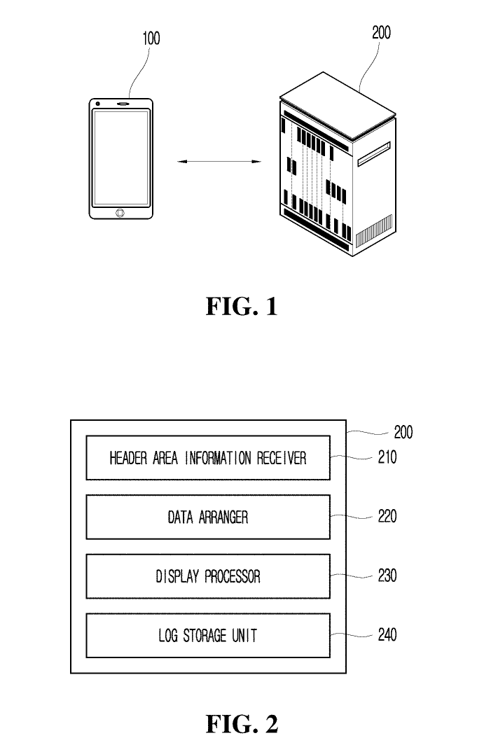

FIG. 1 is a diagram schematically illustrating a configuration of a system for providing a data management service which is capable of column grouping according to one embodiment of the present invention.

Referring to FIG. 1, the data management system according to one embodiment of the present invention includes a user terminal 100 and a service providing server 200.

The user terminal 100 and the service providing server 200 may be mutually connected to each other via a communication network. In this case, the communication network may be configured without regard to its communication mode, such as wired and wireless, and may be configured as various communication networks, such as a local area network (LAN), a metropolitan area network (MAN), a wide area network (WAN), and the like.

The user terminal 100 may include any type of handheld based wireless communication device equipped with a touch screen panel, such as a mobile phone, a smartphone, a personal digital assistant (PDA), a portable multimedia player (PMP), or a tablet PC. In addition, the user terminal 100 may include any devices on which an application can be installed and run, such as a desktop PC, a tablet PC, a laptop PC, and an IPTV including a set-top box.

The user terminal 100 may access the service providing server 200 through an application, a web browser, or the like, and be provided with a data management service. In this case, the service providing server 200 may provide the data management service to the user terminal 100 by providing an operation page for data editing.

The user terminal 100 may display the operation page provided by the service providing server 200 on a screen and further display a data set formed as a table in the operation page. In this case, the data set may be manually input by a user or obtained from a previously stored file, and may be displayed in a data area provided in a portion of the operation page.

The user terminal 100 may transmit information about a header area in which a first group, a second group, and one or more columns are listed to the service providing server 200, wherein the first group includes a first sub-group and a second sub-group as its sub-groups and predetermined columns are grouped as sub-columns in the second group. In this case, the header area information may be configured by the user on the operation page provided to the user terminal 100.

When the service providing server 200 performs data arrangement on the basis of the header area information such that data values of the plurality of columns are listed on each of a plurality of rows corresponding to position information about positions of headers of the plurality of columns included in the header area, the user terminal 100 may display a data-arrangement completed table in the operation page.

According to one embodiment, when a position of a specific column is changed by a user's dragging operation on the operation page, the user terminal 100 may further transmit a position change log of the pertinent column when transmitting the header area information in which the specific column is moved to another position, thereby allowing the position change log to be recorded in the service providing server 200.

The service providing server 200 may provide the operation page for data editing to the user terminal 100. When the service providing server 200 receives the information about the header area in which the first group including the first sub-group and the second sub-group as sub-groups, the second group having predetermined columns grouped as sub-columns therein, and one or more columns are listed, the service providing server 200 may perform data arrangement on the basis of the received header area information such that data values of each of the plurality of columns are listed on each of a plurality of rows corresponding to position information about positions of headers of the plurality of columns in the header area.

According to one embodiment, in the service providing server 200, when header area information in which a position of a specific column is changed by a user's dragging operation on the operation page provided to the user terminal 100 is received, the position change log of the specific column included in the received header area information may be stored.

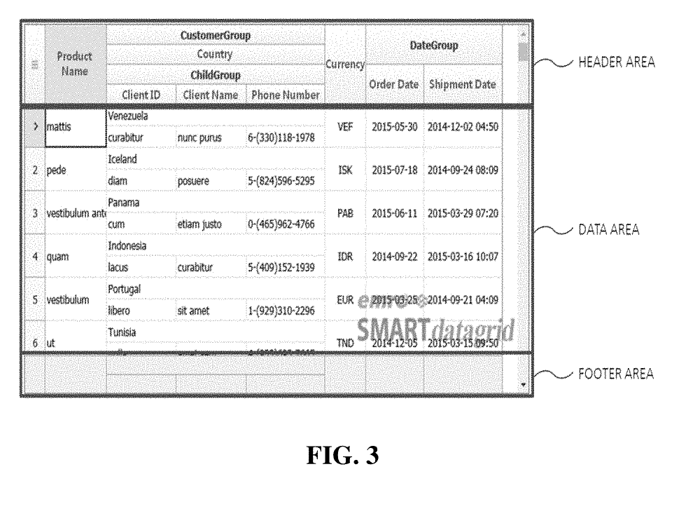

FIG. 2 is a block diagram illustrating a configuration of a service providing server 200 according to one embodiment of the present invention.

Referring to FIG. 2, the service providing server 200 according to one embodiment of the present invention includes a header area information receiver 210, a data arranger 220, a display processor 230, and a log storage unit 240.

Hereinafter, the configuration of the service providing server 200 will be described in detail with reference to embodiments of a table displayed on the operation page according to grouping or layout change of columns of the table.

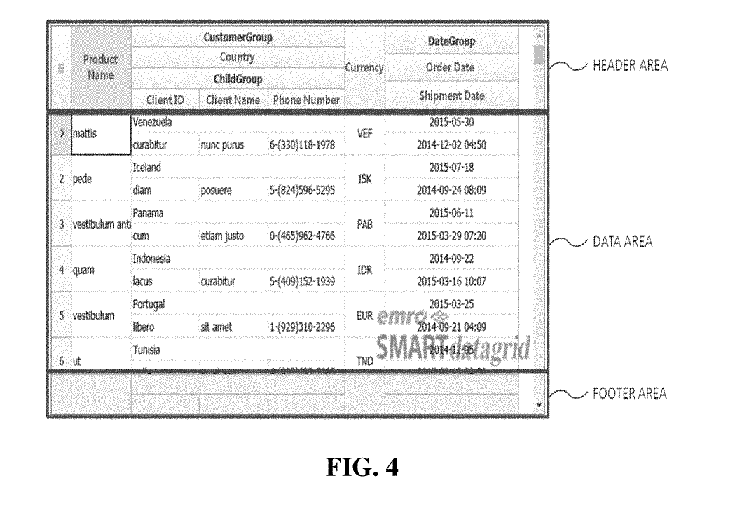

First, the service providing server 200 may provide the operation page for data editing to the user terminal 100. In this case, the service providing server 200 may provide the operation page implemented as a work sheet, include a header area on a portion thereof to display pieces of group header information about groups of column headers or columns, and include a data area on another portion thereof in which data values corresponding to the respective column headers are listed. According to one embodiment, the operation page may further include a footer area on its lower portion. The operation page will be described in detail with reference to FIG. 3.

FIG. 3 is a diagram illustrating an operation page displaying a table on which predetermined columns are grouped.

As shown in FIG. 3, the service providing server 200 may provide a portion of the operation page as the header area, provide another portion of the operation page as a data area, and provide another portion of the operation page as a footer area. In this case, the header area is located at an upper part of the operation page, and the size of the header area is flexibly changed according to the configuration of a grouping made by the user.

A plurality of data values in the form of a table may be displayed in the data area of the operation page. In this case, the plurality of data values may be formed as a table consisting of a plurality of rows and columns, and may be manually input by the user or obtained from a previously stored file.

The header area information receiver 210 may receive information about a header area in which the first group including the first sub-group and the second sub-group as sub-groups, the second group having predetermined columns grouped as sub-columns therein, and one or more columns are listed. In this case, the first sub-group and the second sub-group may be sub-groups into which one or more columns are grouped, and the first sub-group may include the second sub-group as its sub-group.

For example, as shown in FIG. 3, the table may be formed such that a first group, a second group, and a plurality of columns, the “Product Name” column and “Currency” column, are listed, wherein the first group includes: a second sub-group named “ChildGroup” into which the “Client ID” column, “Client Name” column, and “Phone Number” column are grouped as sub-columns; and a first sub-group named “CustomerGroup” into which the second sub-group and the “Country” column are grouped together, and the second group named “DateGroup” includes the “Order Date” column and “Shipment Date” column grouped together as sub-columns.

In addition, in the information about the header area, a group header describing identification information of a group may be positioned at the top of each of the first sub-group, the second sub-group, and the second group into which the one or more columns are grouped as sub-columns.

For example, as shown in FIG. 3, for the second sub-group into which the “Client ID” column, “Client Name” column, and “Phone Number” column are grouped together as sub-columns, identification information of the second sub-group, “ChildGroup,” may be located and displayed at the top of the sub-columns. In addition, identification information, “CustomerGroup,” of the first sub-group into which the second sub-group and the “Country” column are grouped as sub-columns may be located and displayed at the top of the “Country” column, which is a sub-column of the first sub-group. Here, since the second sub-group, “ChildGroup,” is included in the first sub-group, the second sub-group may be positioned and displayed under the first sub-group.

Accordingly, the header area information receiver 210 may receive the header area information which includes headers (e.g., “Client ID,” “Client Name,” “Phone Number,” and “Country” in FIG. 3) of a plurality of columns included in the first sub-group and the second sub-group which are sub-groups of the first group, headers (e.g., “Order Date” and “Shipment Date”) in FIG. 3) of a plurality of columns included in the second group, headers (e.g., “Product Name” and “Currency” in FIG. 3) of one or more columns, and headers (e.g., “CustomerGroup,” “ChildGroup,” and “DateGroup”) of the first sub-group, the second sub-group, and the second group.

The data arranger 220 may perform data arrangement on the basis of the header area information received through the header area information receiver 210 such that data values of each of a plurality of columns are listed on each of the plurality of rows corresponding to position information of the headers of the plurality of columns included in the header area.

According to one embodiment of the present invention, since the first group includes the first sub-group and the second sub-group as sub-groups thereof and the first sub-group includes the second sub-group, the header area information received through the header area information receiver 210 indicates that the sub-column header of the second sub-group is positioned below the sub-column header of the first sub-group, and the data arranger 220 may perform data arrangement such that data values of the second sub-group are listed below data values of the first sub-group in each of the plurality of rows when data arrangement for the first group is performed on the basis of the received header area information.

In other words, the header area information of the first group received through the header area information receiver 210 may consist of four rows within the header area, wherein a group header (e.g., identification information of the first sub-group) of the first sub-group may be positioned in the first row, a sub-column header of the first sub-group may be positioned in the second row, a group header (e.g., identification information of the second sub-group) of the second sub-group may be positioned in the third row, and a sub-column header of the second sub-group may be positioned in the fourth row.

With respect to the header area information of the first group, data values in the form in which only headers of columns except for the group headers are configured for each row may be listed in the data area. That is, in the header area information of the first group which consists of four rows, data values corresponding to the sub-column headers of the first sub-group positioned in the second row and data values corresponding to the sub-column headers of the second sub-group positioned in the fourth row are listed on each of the plurality of rows, and, in turn, a data area including a total of two rows in which the data values of the first sub-group and the data values of the second sub-group are listed in each of the plurality of rows may be provided through the operation page.

For example, as shown in FIG. 3, since “Client Name,” “Client Name,” and “Phone Number” which are sub-column headers of the second sub-group are positioned below the sub-column header “Country” of the first sub-group, the data arranger 220 may perform data arrangement such that a data value of “Client ID” column, a data value of the “Client Name” column, and a data value of the “CountryPhone” column are listed below a data value of the “Country” column.

Meanwhile, when the data arranger 220 performs data arrangement for the second group on the basis of the header area information received through the header area information receiver 210, the data arranger 220 may perform data arrangement such that data values of each of the plurality of sub-columns are listed in each of the plurality of rows corresponding to the arrangement of the headers of the sub-columns of the second group in the header area.

For example, as shown in FIG. 3, the headers of the “Order Date” column and “Shipment Date” column are horizontally arranged below the second group header “DateGroup”, and thus the data arranger 220 may perform data arrangement such that the data value of the “Order Date” column and the data value of the “Shipment Date” column are horizontally arranged in each of the plurality of rows corresponding to the above-described header area information.

In addition, for one or more columns which are not grouped, the data arranger 220 may perform data arrangement such that data values of the respective columns are listed corresponding to the arrangement of the headers of the corresponding columns in the received header area information.

For example, as shown in FIG. 3, the data arranger 220 may perform data arrangement corresponding to the received header area information such that data values of the “Product Name” column are listed below the header of the “Product Name” column in the header area information and data values of the “Currency” column are listed below the header of the “Currency” column.

When the data arrangement is performed by the data arranger 220, the display processor 230 may process the data-arranged table to be displayed on the operation page.

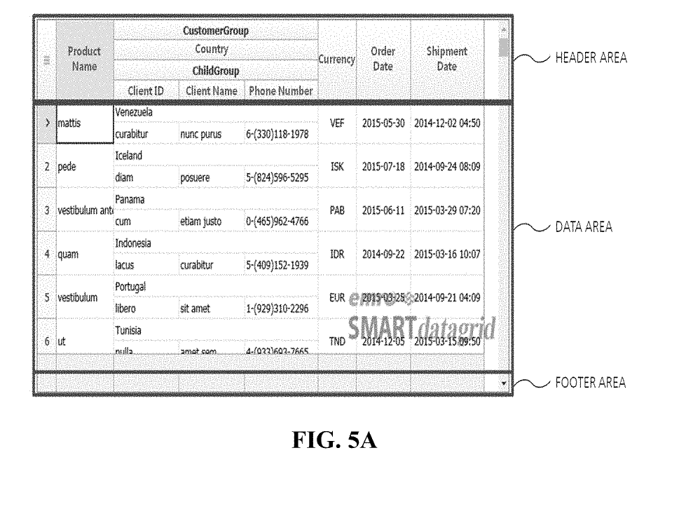

According to one embodiment of the present invention, the service providing server 200 may change the arrangement direction of the sub-columns in the second group according to the user's setting. This operation will be described in detail with reference to FIGS. 4A and 4B. However, the group in which the arrangement direction of the sub-columns can be changed is not limited to the second group.

FIGS. 4A and 4B are diagrams illustrating an operation page on which a table in which an arrangement direction of sub-columns of the second group is changed is displayed according to one embodiment of the present invention.

First, as a user selects the setting for change of a sub-column arrangement direction for the second group on the operation page, an arrangement direction of a header of the sub-column of the second group in the header area may be changed, and accordingly, the header area information receiver 210 may receive header area information in which the arrangement direction of the sub-column header of the second group is changed.

For example, when the user selects the setting of change of a sub-column arrangement direction for “DateGroup” on the operation page, the header area information receiver 210 may receive header area information in which the arrangement direction of the headers of the “Order Date” column and “Shipment Date” column, which are grouped into “DateGroup” as sub-columns, is changed from a horizontal direction to a vertical direction.

In response to the change of the header arrangement direction of the sub-columns of the second group, the data arranger 220 may perform data arrangement such that data values of the respective sub-columns of the second group are listed in the same direction as the arrangement direction of the headers of the corresponding sub-columns.

For example, when header area information in which the header of the “Shipment Date” column is located below the header of “Order Date” column of “DateGroup” is received according to the change of the arrangement direction of the headers of the “Order Date” column and “Shipment Date” column, which are sub-columns of “DateGroup,” from a horizontal direction to a vertical direction, the data arranger 220 may perform data arrangement such that a data value of the “Shipment Date” column is located below a data value of the “Order Date” column in each of a plurality of rows.

When the data arrangement in which the arrangement direction of the sub-columns in the second group is changed is completed by the data arranger 220, the display processor 230 may process the data-arrangement completed table to be displayed on the operation page.

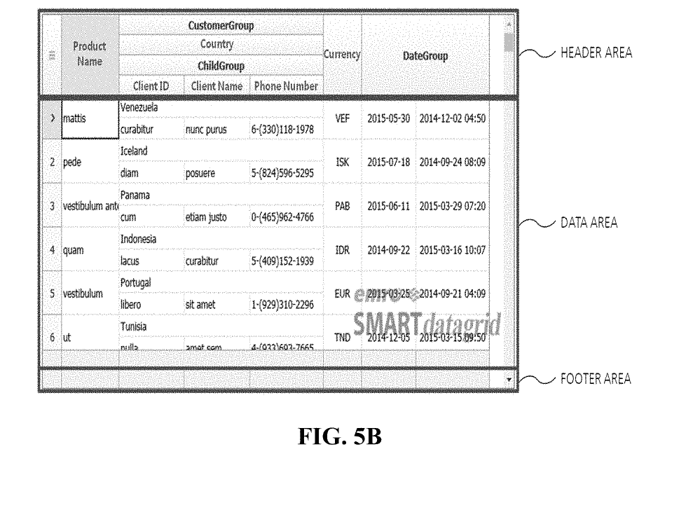

In addition, according to one embodiment of the present invention, the service providing server 200 may provide the user with a table in which the header of the second group is set to be displayed or hidden according to the user's setting, or provide the user with a table in which the headers of sub-columns in the second group are set to be displayed or hidden. This operation will be described in detail with reference to FIG. 5. However, the group for which the header of the group or the headers of sub-columns in the group can be set to be displayed or hidden is not limited to the second group.

FIG. 5 is a diagram illustrating an operation page on which a table in which a group header or a header of a sub-column in a group is set to be hidden is displayed according to one embodiment of the present invention.

First, referring to FIG. 5A, according to a user's selection of hiding or displaying a group header of the second group on the operation page, the header of the second group in the header area may be hidden or displayed, and accordingly, the header area information receiver 210 may receive header area information in which the header of the second group is set to be hidden or displayed.

For example, when the user selects the setting of hiding a group header of the “DateGroup” group on the operation page, the header area information receiver 210 may receive header area information in which only the headers of sub-columns, the “Order Date” column and “Shipment Date” column, in the “DateGroup” group are displayed while the header of the “DateGroup” group is hidden and not displayed.

Since the header of the group within the header area is displayed only in the header area and not in the data area, the data arranger 220 may perform data arrangement without regard to the header display setting of the second group, such that data values corresponding to the respective sub-columns in the second group are listed in each of a plurality of rows in the same arrangement as that of the headers of the corresponding columns in the header area. That is, even when the header display setting of the second group is changed, the arrangement within the data area may be maintained without being re-performed.

For example, even when the header “DateGroup” of the second group is set to be hidden, header area information in which headers of the “Order Date” column and “Shipment Date” column are horizontally arranged is received through the header area information receiver 210, and accordingly, the data arranger 220 may arrange the data such that a data value of the “Order Date” column and a data value of the “Shipment Date” column are horizontally arranged in each of the plurality of rows.

When the data arranger 220 completes the data arrangement in which the header display setting of the second group is changed, the display processor 230 may process the data-arrangement completed table to be displayed on the operation page.

In addition, referring to FIG. 5B, according to the user's selection of hiding or displaying a header of a sub-column in the second group on the operation page, the sub-column header of the second group in the header area may be hidden or displayed, and accordingly, the header area information receiver 210 may receive header area information in which the header of each sub-column of the second group is set to be hidden or displayed.

For example, when the user selects the setting of hiding sub-column headers of the “DateGroup” group on the operation page, the header area information receiver 210 may receive header area information in which only the group header of the “DateGroup” group is displayed while headers of sub-columns, the “Order Date” column and “Shipment Date” column, of the “DateGroup” group are hidden and not displayed.

Even when the sub-column header of the second group is set to be hidden, the data arranger 220 may perform data arrangement as in the case where the sub-column header of the second group is set to be displayed.

For example, even when the headers of the “Order Date” column and “Shipment Date” column, which are sub-columns of the “DateGroup” group, are set to be hidden, the data arranger 220 may perform data arrangement as in the case where the headers of the “Order Date” column and “Shipment Date” column are set to be displayed.

When the data arranger 220 completes the data arrangement in which the sub-column display setting of the second group is changed, the display processor 230 may process the data-arrangement completed table to be displayed on the operation page.

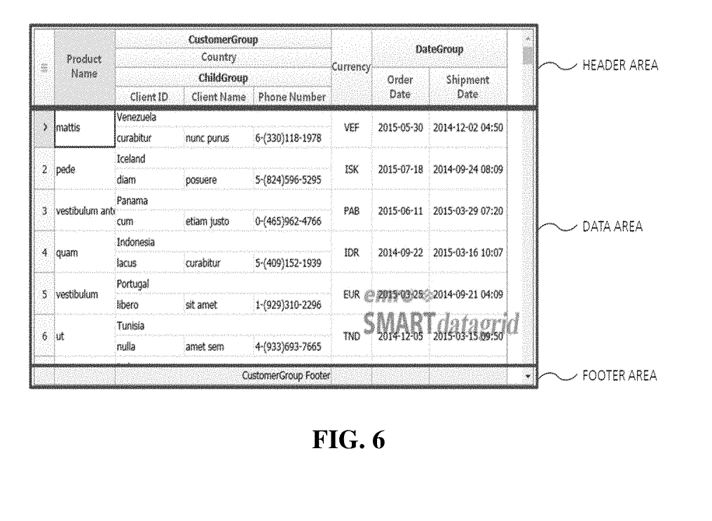

According to one embodiment of the present invention, the service providing server 200 may process a table including a footer area to be displayed on the operation page provided to the user terminal 100. This operation will be described in detail with reference to FIG. 6.

FIG. 6 is a diagram illustrating an operation page on which a table including a footer area is included according to one embodiment of the present invention.

The display processor 230 may provide a footer area corresponding to the group header in the header area or provide a footer area corresponding to the entire header area including the sub-column headers of the group according to whether the footer column is set to be displayed by a user. Accordingly, the display processor 230 may process the footer area to be displayed on the operation page in which data arrangement is completed. In this case, the footer area may be located and displayed at the bottom of the operation page.

For example, when the footer column is set to be not displayed by the user, the display processor 230 may provide only the footer area corresponding to the header of the “CustomerGroup” group and allow the corresponding footer to be displayed at the bottom of the operation page. On the contrary, when the footer column is set to be displayed by the user, the display processor 230 may provide a footer area corresponding to the sub-columns in the entire header area and allow the corresponding footer to be displayed at the bottom of the operation page.

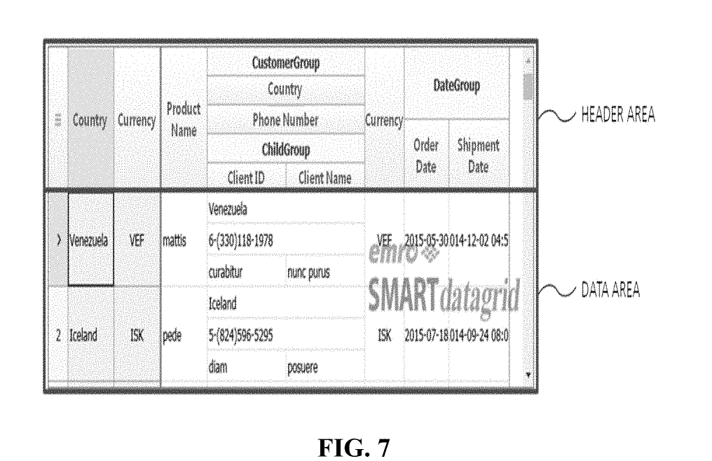

In addition, according to one embodiment of the present invention, the service providing server 200 may receive header area information in which a position of a specific column is changed through a user's dragging operation on the operation page. This operation will be described in detail with reference to FIG. 7.

FIG. 7 is a diagram illustrating an operation page on which a table in which a position of a specific column is changed through a user's dragging operation is displayed according to one embodiment of the present invention.

First, the user move the column header to an arbitrary position by selecting and dragging a header of a column to be moved among a plurality of column headers arranged in the header area. Accordingly, the header area information receiver 210 may receive header area information in which the position of the column header is changed.

In this case, when specific columns in the table are previously set as scroll-fixed target columns, the change of a column head position by a user's dragging operation may allow a column that is not the scroll-fixed target column to be moved to an area in which the scroll-fixed target columns are collected, and it may allow grouping of a column that is not grouped into a specific group by moving it to an area in which columns of the specific group are collected. In addition, a column which is grouped as a sub-column of a specific group may be moved to another position and be ungrouped from the specific group, a column grouped into the first sub-group may be moved to the second sub-group, and the arrangement order of the sub-columns in the second group may be changed.

In order to correspond to the header area in which a header of a specific column is moved, the data arranger 220 may perform data arrangement such that data values of each of the plurality of columns are listed corresponding to the position information about the positions of headers of the corresponding columns. When the data arranger 220 completes the data arrangement changed according to the movement of the header of the specific column, the display processor 230 may process the data-arrangement completed table to be displayed on the operation page.

In this case, when the header area information in which the position of the specific column is changed by a user's dragging operation on the operation page is received through the header area information receiver 210, the service providing server 200 may store and record a position change log of the specific column whose position is changed in the log storage unit 240.

As described above, according to one embodiment of the present invention, a plurality of columns may be grouped into one group and the group of the plurality of columns may be grouped into a new group by belonging to another group. Therefore, there is no inconvenience in which the user scrolls in the horizontal direction in order to view a plurality of pieces of data, and hence it is possible to provide convenience when the user browses data.

In addition, according to the embodiment of the present invention, since the layout configuration of column-grouped data table can be changed freely, it is possible to provide the user with data tables in various layouts.

Further, according to the embodiment of the present invention, since a column grouping function based on web-language-based code information is provided and the function is implemented through a web browser or a web-based application in a user terminal, Active X, a plug-in, or a separate execution program (or file) is not required to implement the operation.

However, the effects of the present invention are not limited to the effects described above, and other effects that have not been set forth herein will be clearly understood from the detailed description of the present invention or the appended claims by those skilled in the art.

As the foregoing description of the invention is for illustrative purposes, a person having ordinary skilled in the art will appreciate that other specific modifications can be easily made without departing from the technical spirit or essential features of the invention. Therefore, the foregoing embodiments should be regarded as illustrative rather than limiting in all aspects. For example, some components, each of which has been described as being a single form, can be embodied in the distributed form, whereas some components, which have been described as being distributed, can be embodied in the combined form.

The scope of the present invention is not defined by the detailed description as set forth above but by the accompanying claims of the invention. It should also be understood that all changes or modifications derived from the definition and scope of the claims and their equivalents fall within the scope of the invention.

What is claimed is:

1. A method of providing a data management service capable of column grouping by a service providing server, the method comprising:
receiving header area information about a header area through an operation page provided to a user terminal, wherein a first group including a first sub-group and a second sub-group as sub-groups thereof, a second group having predetermined columns grouped as sub-columns therein, and one or more columns are listed in the header area;
performing data arrangement on the basis of the received header area information such that data values of a plurality of columns are listed corresponding to position information about headers of the plurality of columns included in the header area wherein the headers are positioned in each of a plurality of rows; and
processing a table in which the data arrangement is completed to be displayed on the operation page.

2. The method of claim 1, wherein one or more columns are grouped as sub-columns in each of the first sub-group and the second sub-group.

3. The method of claim 1, wherein in the header area information, a group header describing identification information of a group is positioned at a top of each of the second group, the first sub-group and the second sub-group, into which the one or more columns are grouped as sub-columns.

4. The method of claim 1, wherein the performing of the data arrangement includes performing the data arrangement such that data values of the second sub-group are listed below data values of the first sub-group in each of the plurality of rows when the first sub-group includes the second sub-group as a sub-group thereof and headers of one or more columns included in the second sub-group are positioned below headers of one or more columns included in the first sub-group in the header area.

5. The method of claim 1, wherein the performing of the data arrangement includes performing the data arrangement such that data values of a plurality of columns of the second group are horizontally or vertically listed in each of the plurality of rows when header area information in which an arrangement direction of the sub-columns of the second group is changed to a horizontal or vertical direction is received.

6. The method of claim 1, wherein the receiving of the header area information includes receiving the header area information in which a header of the second group is set to be hidden or displayed.

7. The method of claim 1, wherein the performing of the data arrangement includes performing the data arrangement in a case where a header of a predetermined sub-column of the second group is set to be displayed even when a header of a predetermined sub-column of the second group is set to be hidden.

8. The method of claim 1, wherein the processing of the table includes processing the table to be displayed on the operation page wherein the table includes a footer area corresponding to position information about positions of headers of each of the plurality of groups included in the header area or positions of headers of each of the columns.

9. The method of claim 1, wherein the receiving of the header area information includes receiving the header area information in which a position of a specific column is changed through a user's dragging operation on the operation page.

10. The method of claim 1, further comprising:
storing a position change log of a specific column when header area information in which a position of the specific column is changed through a user's dragging operation on the operation page is received.

11. A service providing server comprising:
a header area information receiver configured to receive header area information about a header area through an operation page provided to a user terminal, wherein a first group including a first sub-group and a second sub-group as sub-groups thereof, a second group having predetermined columns grouped as sub-columns therein, and one or more columns are listed in the header area;
a data arranger configured to perform data arrangement on the basis of the received header area information such that data values of a plurality of columns are listed corresponding to position information about headers of the plurality of columns included in the header area wherein the headers are positioned in each of a plurality of rows; and
a display processor configured to process a table in which the data arrangement is completed to be displayed on the operation page.

12. The service providing server of claim 11, wherein one or more columns are grouped as sub-columns in each of the first sub-group and the second sub-group.

13. The service providing server of claim 11, wherein in the header area information, a group header describing identification information of a group is positioned at a top of each of the second group, the first sub-group and the second sub-group, into which the one or more columns are grouped as sub-columns.

14. The service providing server of claim 11, wherein the data arranger performs the data arrangement such that data values of the second sub-group are listed below data values of the first sub-group in each of the plurality of rows when the first sub-group includes the second sub-group as a sub-group thereof and headers of one or more columns included in the second sub-group are positioned below headers of one or more columns included in the first sub-group in the header area.

15. The service providing server of claim 11, wherein the data arranger performs the data arrangement such that data values of a plurality of columns of the second group are horizontally or vertically listed in each of the plurality of rows when header area information in which an arrangement direction of the sub-columns of the second group is changed to a horizontal or vertical direction is received.

16. The service providing server of claim 11, wherein the header area information receiver receives the header area information in which a header of the second group is set to be hidden or displayed.

17. The service providing server of claim 11, wherein the data arranger performs the data arrangement in a case where a header of a predetermined sub-column of the second group is set to be displayed even when a header of a predetermined sub-column of the second group is set to be hidden.

18. The service providing server of claim 11, wherein the display processor processes the table to be displayed on the operation page wherein the table includes a footer area corresponding to position information about positions of headers of each of the plurality of groups included in the header area or positions of headers of each of the columns.

19. The service providing server of claim 11, wherein the header area information receiver receives the header area information in which a position of a specific column is changed through a user's dragging operation on the operation page.

20. The service providing server of claim 11, further comprising: a log storage unit configured to store a position change log of a specific column when header area information in which a position of the specific column is changed through a user's dragging operation on the operation page is received.
